(19) United States
(12) Patent Application Publication
(10) Pub. No.: US 2006/0107607 A1
(43) Pub. Date: May 25, 2006

(54) Stackable trim molding system and method

(75) Inventor: Galen Dillon, Fostoria, OH (US)

Correspondence Address: BAKER & HOSTETLER LLP;Washington Square, Suite 1100, 1050 Connecticut Avenue, N.W., Washington, DC, 20036, US

(73) Assignee: Roppe Corporation

(21) Appl. No.: 10/991,502

(22) Filed: Nov. 19, 2004

(51) Int. Cl. E06B 1/04

(52) U.S. Cl. 52/211

(57) ABSTRACT

Stackable trim molding system is provided. The stackable trim molding system includes a base shoe made of a resilient manmade material having a bottom end configured to contact a floor and a wall base of resilient manmade material having a bottom end configured to communicate with a top end of a base shoe to form a clean border with the base shoe and stacked on top of the base shoe. Some embodiments include a top trim mounted to the wall base. Some embodiments include a top trim mounted to the wall base with an integral cove toe. Some embodiments include a top trim mounted to an existing wall base. A method of installing the trim system is provided. The method includes trimming existing wall base to remove the cove toe to allow for the installation of a base shoe between the wall base and the floor.

### FIELD OF THE INVENTION

The present invention relates generally to molding that is located at the base of interior walls. More particularly, the present invention relates to a stackable trim molding system where the molding is made of a resilient man-made material.

### BACKGROUND OF THE INVENTION

Molding is often placed at a base section of a wall, where the wall meets the floor. The molding receiving proposed modifications and improvements is commonly referred to as wall base, cove base, base board, base molding, mop board and/or skirting. For the purposes of this document the part will be referred to as a wall base. Molding is used whether a floor be hardwood, carpet or resilient flooring to provide a transition between the wall and the flooring. The trim can provide several useful functions. For example, if the wall is painted, the painting can extend to nearly the floor and then be covered by trim creating a clean, crisp line between the trim and the paint. The same can be true for when the wall is wallpapered. However, if a wall is to be repainted, to achieve a crisp line between the end of the wall, the trim must be taped prior to painting, a slow and steady approach to carefully painting the wall but not contacting the trim must be adopted or the trim must be removed before the paint is applied. These methods are laborious. In the case of removing the trim, often the act of removing the trim causes it to be destroyed, and new trim must be applied after the wall is repainted. These methods can be time-consuming and costly.

Other problems with existing trim is that the trim is susceptible to damage. For example, often trim is made of wood, which can crack or break, or be gouged which necessitates the trim being repaired or replaced. Another problem associated with trim is that if a floor surface is to be replaced whether it be replacing the carpet, or adding carpet over an uncarpeted floor, or any other type of floor replacement, often the trim must be replaced. The trim often needs replacement because the new flooring will have a different height than the old flooring, or the act of removing the flooring will cause the trim to crack and break. Wood trim can be expensive and labor intensive to be treated whether by painting or being stained, or otherwise given a surface treatment in order to preserve the wood. Further, wood trim must be machined in order to give the trim contours such as beveled edges or other contours that are often desirable. The need to work the wood trim of course, can increase its costs.

Accordingly, it is desirable to provide a trim molding system and method that can overcome some of the problems associated with traditional trim systems. For example, it would be desirable to provide a trim system where the trim is resilient and not prone to cracking and other types of damage. Further, it would be desirable for trim to be able to achieve shapes and contours without the expense of machining as required in wood trim. In addition, it can be desirable to provide a trim molding system and method that permits re-carpeting and repainting or wallpapering of a wall without requiring removal of all of the trim and then replacement of the trim after the flooring has been replaced, or the wall has been painted or wall papered.

### SUMMARY OF THE INVENTION

The foregoing needs are met, to a great extent, by the present invention, wherein in one aspect an apparatus is provided that in some embodiments a trim molding system and method that permits re-carpeting and repainting or wallpapering of a wall without requiring removal of all of the trim and then replacement of the trim after the flooring has been replaced, or the wall has been painted or wall papered.

In accordance with one embodiment of the present invention, a stackable trim molding system is provided. The system includes: a base shoe made of a resilient, man-made material and having a bottom end configured to contact a floor; and a wall base made of a resilient, man-made material having a bottom end configured to communicate with a top end of the base shoe to form a clean border with the base shoe when stacked on top of the base shoe.

In accordance with another embodiment of the present invention, a stackable trim molding system is provided. The system includes: a wall base made of a resilient, man-made material; with an inclusive cove toe wherein the toe is substantially perpendicular to the wall base; and a top trim made of a resilient, man-made material, having a bottom end configured to communicate with a top end of the wall base to form a clean border with the wall base when stacked on top of the wall base.

In accordance with another embodiment of the present invention, a stackable trim molding system is provided. The system includes: a base shoe made of a resilient, man-made material and having means for connecting to a floor to smoothly butt up against the floor; and a wall base made of a resilient, man-made material having means for connecting with a top end of the base shoe to form a clean border with the base shoe when stacked on top of the base shoe.

In accordance with another embodiment of the present invention, a stackable trim molding system is provided. The system includes: a wall base made of a resilient, man-made material having means for contacting a floor; and a top trim made of a resilient, man-made material, having means for connecting with a top end of the wall base to form a clean border with the wall base when stacked on top of the cove base.

In accordance with another embodiment of the present invention, a method of installing trim is provided. The method includes: attaching the base shoe to a wall to where a bottom part of the base shoe is provided to a floor; and attaching the wall base to the wall via the adhesive inserting the bottom edge of the wall base into the top groove of the base shoe.

In accordance with another embodiment of the present invention, a method of installing trim is provided. The method includes: attaching the wall base to a wall; contacting a floor surface with a cove toe portion of the wall base; and applying a top trim above the wall base.

In accordance with another embodiment of the present invention, a method of making trim is provided. The method includes: molding or extruding a man-made, resilient material into a wall base having at least one of: a top side configured to mate with a top trim when the top trim is stacked on top of the wall base and a bottom side configured to mate with a base shoe when the wall base is stacked on top of the base shoe.

In accordance with yet another embodiment of the present invention, a stackable trim molding system is provided. The system includes: a base shoe; and wall base having a bottom end configured to communicate with a top end of the base shoe to form a clean border with the base shoe when stacked on top of the base shoe.

In accordance with yet another embodiments of the present invention, a method of converting a trim molding system with a cove toe on a wall base to a non-toe system is provided. The method includes trimming the toe off of a wall base.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is perspective view illustrating a stackable trim system according to a preferred embodiment of the invention.

FIG. 2 is a perspective view of a stackable trim system where no top trim is used.

FIG. 3 is a perspective view of a stackable trim system having a groove for accepting carpet in the base shoe.

FIG. 4 is a perspective view of a stackable trim system having the wall base without a cove toe or base shoe.

FIG. 5 is a perspective view of a stackable trim system where the wall base has a cove toe.

FIG. 6 is a perspective view of a stackable trim system showing a cove toe removed from the wall base and being replaced with a base shoe.

### DETAILED DESCRIPTION

An illustrated embodiment of the invention will now be described with reference to the drawing figures, in which like reference numerals refer to like parts throughout. An embodiment in accordance with the present invention provides a stackable trim system where the trim is made of multiple pieces of a resilient manmade material. The trim is stacked on top of other pieces of trim to achieve a molding system at the base of a wall. Some embodiments of the invention include a method of installing stackable trim systems. Yet other embodiments of the invention include a method for manufacturing a stackable trim system.

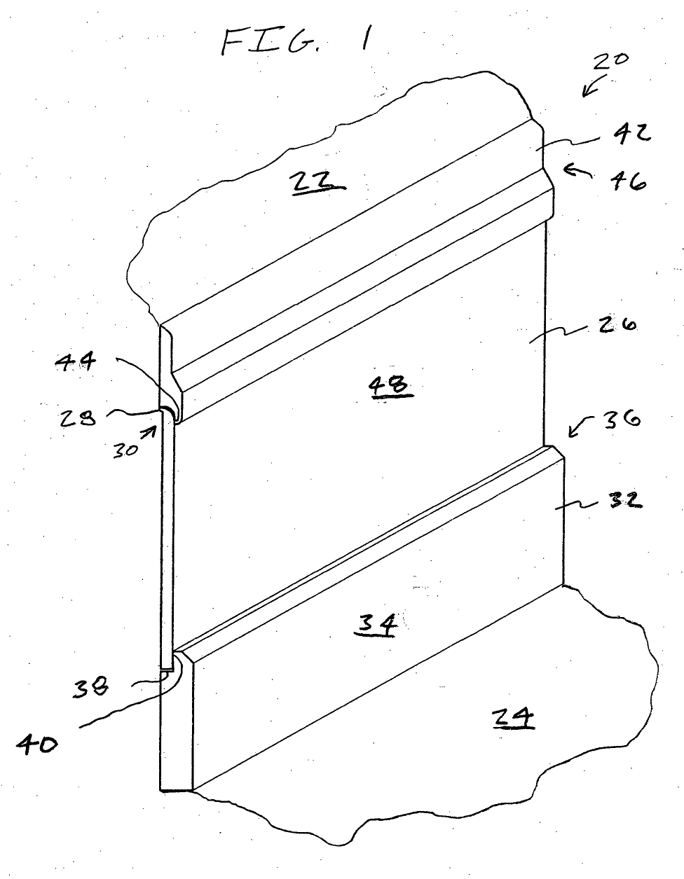

An embodiment of the present inventive apparatus is illustrated in FIG. 1. FIG. 1 shows a stackable trim molding system 20. The stackable trim molding system 20 is installed against a wall 22 where the wall 22 meets the floor 24. The stackable trim molding system 20 includes a wall base 26. The wall base is made of a resilient manmade material. For example, it may be made of rubber, including vulcanized rubber. It could be made of thermoplastic rubber, or vinyl, or any other suitable substance. The wall base 26 is substantially flat on the back side and generally textured to accept adhesive, but some embodiments have a ridge 28 located near the top 30 of the wall base 26, which helps seal the wall base 26 to the wall 22 to which the wall base 26 is adhered.

In some embodiments of the invention, the wall base 26 is adhered to a wall 22 by a latex adhesive, similar to adhesives commonly used for installing other types of trim. Other ways of applying the trim system 20 to a wall 22 can include a glue (perhaps factory applied) that can be applied to the back of the wall base 26 (or other parts of the molding system 20 discussed below). The glue may be protected until installation by a removable release paper that is removed to expose the glue prior to installation. In other embodiments of the invention, a double faced, scrim-reinforced tape is used. The tape is carried on a release paper. It is attached to the wall base 26 (or another component of the trim system 20), then the paper is removed and the component of the trim system 20 is placed where desired. Alternatively, the wall base 26 may be adhered to the wall 22 using any suitable adhesive or fastener in accordance with the present invention.

In some of the embodiments of the present invention, the wall base 26 is stacked on top of a base shoe 32. The base shoe 32 provides the transition between the floor 24 and the wall base 26. The base shoe 32 may be made of the same man-made material as the wall base 26. There are other embodiments that may be made of a different man-made material than the wall base 26.

The base shoe 32 has a front face 34 which may be contoured for decorative reasons, or in many embodiments it is simply flat as shown in FIG. 1. A top portion 36 of the base shoe 32 may be contoured for decorative purposes.

In some embodiments of the invention, the stackable trim molding system 20 includes not only the wall base 26, the base shoe 32, but also a top trim piece 42. The base shoe 32, the wall base 26 and the top trim 42 all can stack on each other and have features that assist in the stacking and provide aesthetically clean transitions between the pieces of trim 26, 32, 42.

The top 36 of the base shoe 32 has a groove 38 defined in part by a lip 40 that is dimensioned and configured to allow the wall base 26 to fit inside the groove 38. This communication between the wall base 26 and the base shoe 32 provide a clean transition between the wall base 26 and the base shoe 32.

Having a lip 40 on the base shoe 32 permits the base shoe 32 to be removed while leaving the wall base 26 intact. This feature can be useful in instances where the base shoe 32 needs to be removed when a new floor is installed and then the old or new base shoe 32 can be reapplied and all the while, the wall base 26 and top trim 42 can be left the same.

Alternatively, when it is desired to redecorate a room, the wall base 26 can be left and the base shoe 32 and the top trim 42 can be removed and a different base shoe 32 or top trim 42 having the same or different color and/or contour can be applied.

In a similar vein, the top trim 42 has a lip 44 that overlaps the cove base 26 when the top trim 42 is stacked on top of the wall base 26. The configuration having a lip 44 overlap the wall base 26 permits a clean transition between the top trim 42 and the wall base 26. A clean transition refers to a well-defined boundary where there are no gaps between pieces of trim 26, 32, 42 exposing the wall 22 behind the trim 26, 32, 42. In the case of a painted wall to trim boundary, a clean transition has substantially no paint on the trim 26, 32, 42 and the paint on the wall 22 extends all the way to the trim 26, 32, 42 leaving substantially no gap of non-painted wall surface between the painted area on the wall 22 and the trim 26, 32, 42.

For a wallpaper to trim boundary, a clean transition includes a boundary between the wallpaper and trim 26, 32, 42 where there is substantially no non-wallpapered wall area between the wallpaper and the trim 26, 32, 42 and there is substantially no wallpaper overlapping the trim 26, 32, 42.

The lip 44 permits the top trim 42 to be removed in order for the wall 22 to which it is mounted to be painted or wallpapered. Then the top trim 42 can be replaced performing a smooth transition between the top trim 42 and the wall 22. Meanwhile the wall base 26 can remain where it is without having to be removed. The top trim 42 has a contoured front face 46 which permits different contours for the top trim 42. Both the top trim 42 and the base shoe 32 can be adhered to a wall using a standard adhesive such as a latex adhesive, glue protected by release paper, double faced, scrim-reinforced tape, or other suitable fastening means similar to that which is used for the wall base 26.

In some embodiments of the invention, the wall base 26, the base shoe 22 and the top trim 42 can be manufactured by extrusion and manufactured in whatever length is desired. The surfaces of the wall base 26, the base shoe 32 and the top trim 42 may be finished and be ready and appropriate for application without the need of painting or applying any other finishing coat.

Alternatively, in some embodiments of the invention, if it is desired to alter the look of a stackable trim molding system 20, the top trim 42, base shoe 32, and wall base 26 can have different colors, patterns, or profiles which can be mixed and matched. As mentioned, the wall base 26, the base shoe 32 and the top shoe 42 are made of a resilient manmade material, which provides the advantage of being resistant to cracking and chipping. And, as mentioned, if the top trim 42 or the base shoe 32 are damaged, they can individually be replaced without requiring replacement of the entire trim molding system 20. While the wall base 26 as shown in the figures is substantially flat in its front face 48, other embodiments of the invention have patterns or contours in the front face 48 of the wall base 26.

In addition, the front face 34 of the base shoe 32 can also have different curved or angled contours or be relatively flat as shown in the figures.

In addition, the front face 46 of the top trim 42 can also have different curved or angled contours or be relatively flat.

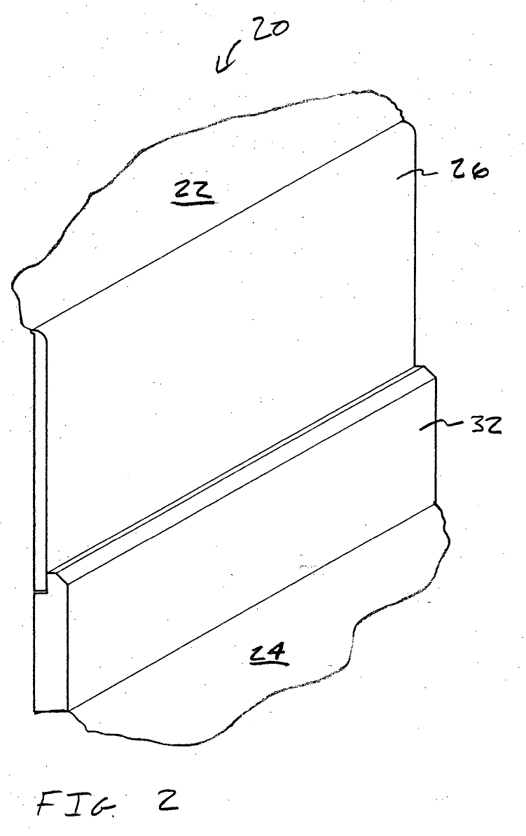

FIG. 2 shows another embodiment of the stackable trim molding system 20. In FIG. 2, there is a wall base 26 on top of a base shoe 32. The base shoe 32 sits on top of the floor 24 and against the wall 22. The wall base 26 is also against the wall 22. There is no top trim piece 42 as the top trim piece 42 is an optional feature in some embodiments of the invention.

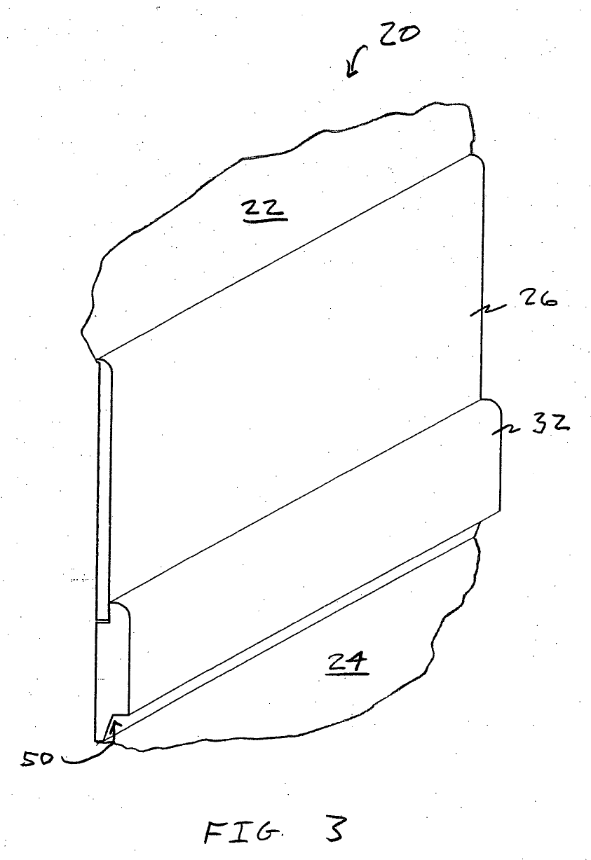

FIG. 3 shows an alternate embodiment of the stackable trim molding system 20 in accordance with the invention. The wall base 26 is placed against the wall 22 and is on top of the base shoe 32 which rests on top of the floor 24. There is a groove 50 in the base shoe 32 that is configured to accept carpeting. In other words, if carpeting is placed on top of the floor 24, it may be placed in the groove 50 and butted against the base shoe 32 to provide a clean transition between the carpeting and the base shoe 32. Again, the optional top trim 42 is absent in the embodiment shown in FIG. 3. However, in other embodiments of the invention, the top trim 42 may be included when the base shoe 32 has the carpet groove 50.

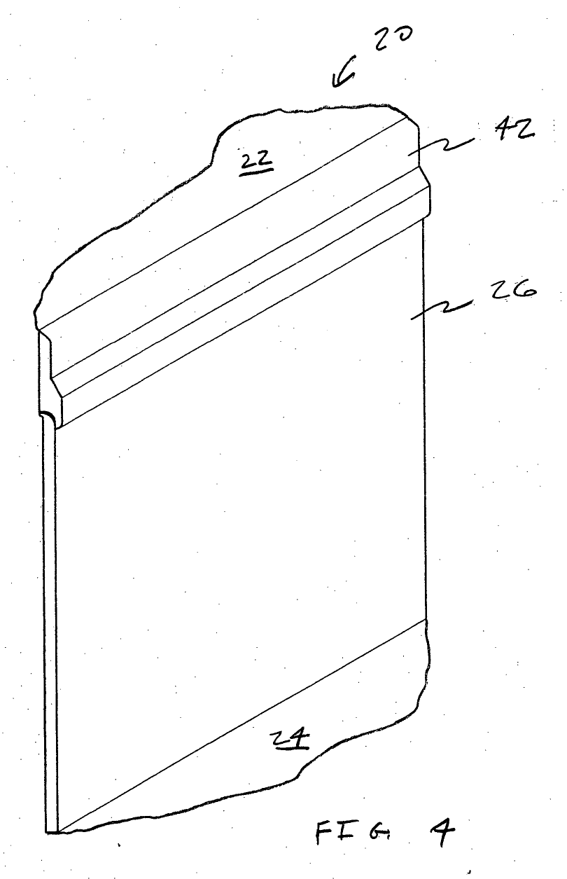

Another embodiment of the invention is shown in FIG. 4. In FIG. 4, the cove base 26 is butted up against the wall 22 and contacts the floor 24. A top trim 42 is set on top of the wall base 32 similar to that as shown and described in FIG. 1. In the embodiment shown in FIG. 4, the trim molding system 20 has no base shoe 32 as the base shoe 32 is an optional element in some embodiments of the invention.

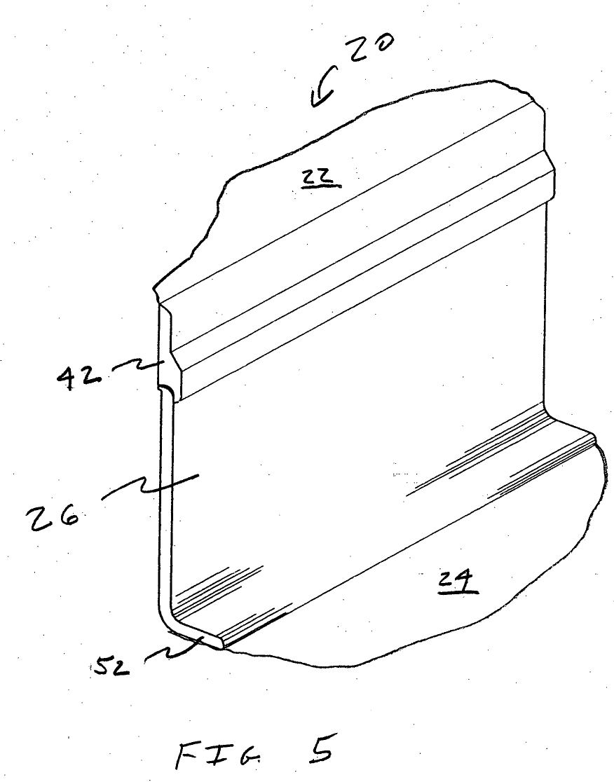

In another embodiment of the invention, as shown in FIG. 5, the trim molding system 20 includes a wall base 26 which includes a cove toe 52. The toe 52 is placed on top of the floor 24. The wall base 26 rests against the wall 22 as well as the top trim 42 that is set on top of the wall base 26 in the manner shown and described with respect to FIG. 1.

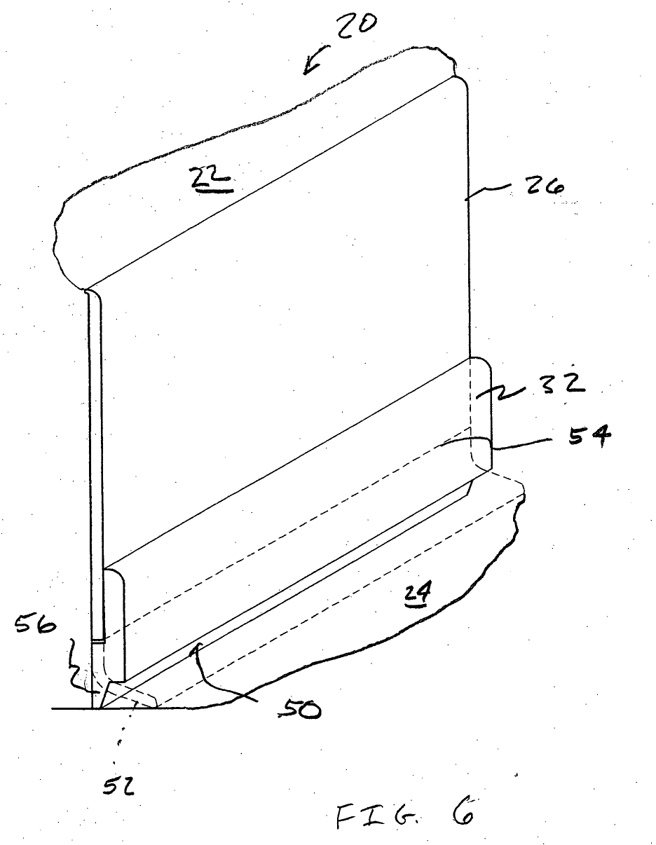

FIG. 6 illustrates in yet another embodiment of the invention wherein the stackable molding system 20 originally had a pre-installed wall base 26 with a cove toe 52. However, the trim molding system 20 has been modified where the toe 52 has been cut or removed along dotted line 54.

The floor 24 shown in FIG. 6 may be a pre-existing floor or floor finish such as resilient tile, wood or some other man-made flooring material. The toe 52 does not normally angle down as shown in FIG. 6 to an exposed sub-floor surface.

Reasons for removing the toe 52 vary, examples include remodeling and changing the look of the trim molding system 26 or adding carpet to the floor 24 and necessitating a new transition between the molding system 20 and the carpet. To replace the removed toe 52, a base shoe 32 has been added to the bottom of the trim molding system 20. The base shoe 32 includes a wall butting section 56 as configured to fit against the wall 22 and may be adhered to the wall 22 by an adhesive. In other embodiments of the invention, the base shoe 32 may also adhere to the wall base 26.

Optionally, and as shown in FIG. 6, the base shoe 32 may have a groove 50 for accepting carpet. In other embodiments of the invention, the base shoe 32 may not have the groove 50. While the embodiment shown in FIG. 6 does not include the top trim 42, in other embodiments of the invention, the top trim 42 may be included set on top of the wall base 26 and adhered to the wall 22.

In accordance with an embodiment of the invention, a method for installing the stackable trim molding system 20 is accomplished. The back side of a base shoe 32 may have an adhesive applied to it, or alternatively, the adhesive can be applied to the wall 22. The base shoe 32 is then attached to the wall 22 via the adhesive. The back side of a wall base 26 may then have an adhesive applied to it, or alternatively, the adhesive can be applied to the wall 22. The wall base 26 is then attached to the wall 22 via the adhesive and then, the adhesive may be applied to the top trim 42 and then the top trim 42 can be attached to the wall 22.

In other embodiments of the invention, the wall base 26, the base shoe 32, or top trim 42 may be applied to a wall 22 using a glue (perhaps factory applied) can be applied to the back of the wall base 26, base shoe 32, or top trim 42. The glue may be protected until installation by a removable release paper that is removed to expose the glue prior to installation. In other embodiments of the invention, a double faced, scrim-reinforced tape is used. The tape is carried on a release paper. It is attached to the wall base 26 (or another component of the trim system 20), the paper is removed and the component of the trim system 20 is placed where desired. Alternatively, the wall base 26, base shoe 32, or top trim 42 may be adhered to the wall 22 using any suitable adhesive or fastener in accordance with the present invention.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A stackable trim molding system comprising:
a base shoe made of a resilient, man-made material and having a bottom end configured to contact a floor; and
a wall base made of a resilient, man-made material having a bottom end configured to communicate with a top end of the base shoe to form a clean border with the base shoe when stacked on top of the base shoe.

2. The stackable trim molding system of claim 1, wherein the base shoe has a groove in the top end of the base shoe and the wall base has a substantially flat bottom end dimensioned to fit into the groove in the top end of the base shoe.

3. The stackable trim molding system of claim 1, further comprising a top trim piece made of a resilient, man-made material and having a bottom end configured to communicate with a top end of the wall base to form a clean border with the wall base when stacked on top of the wall base.

4. The stackable trim molding system of claim 3, wherein the top trim has a groove in the bottom end dimensioned to receive the top end of the wall base.

5. The stackable trim molding system of claim 1, wherein the top trim and the base shoe have a greater thickness than the wall base.

6. The stackable trim molding system of claim 1, further comprising a ridge located near the top of the wall base, for substantially sealing the wall base to the wall when the wall base is adhered to a wall.

7. The stackable trim molding system of claim 1, wherein the base shoe has a substantially flat bottom end.

8. The stackable trim molding system of claim 1, wherein the base shoe has a groove in the bottom end configured to receive a carpet.

9. The stackable trim molding system of claim 1, wherein the system is comprised of at least one of rubber and vulcanized rubber.

10. The stackable trim molding system of claim 1, wherein the system is comprised of thermo-plastic rubber (TPR).

11. The stackable trim molding system of claim 1, wherein the system is comprised of vinyl.

12. The stackable trim molding system of claim 1, wherein a back side of the wall base and the base shoe are configured to adhere to an adhesive.

13. The stackable trim molding system of claim 1, wherein a front face of one or more of the wall base, and the base shoe are contoured.

14. The stackable trim molding system of claim 1, wherein the wall base and the base shoe may be different colors.

15. The stackable trim molding system of claim 1, wherein the wall base and the base shoe when stacked do not adhere to each other.

16. A stackable trim molding system comprising:
a wall base made of a resilient, man-made material;
a cove toe made of a resilient, man-made material, wherein the wall base has a cove toe that is substantially perpendicular to the wall base at the bottom of the wall base; and
a top trim made of a resilient, man-made material, having a bottom end configured to communicate with a top end of the wall base to form a clean border with the wall base when stacked on top of the wall base.

17. The stackable trim molding system of claim 16, wherein the top trim has a groove in the bottom end of the top trim and the wall base has a top end dimensioned to fit into the groove in the bottom end of the top trim when the top trim is stacked on the wall base.

18. The stackable trim molding system of claim 16, further comprising a ridge located near the top of the wall base, for substantially sealing the wall base to the wall when the wall base is adhered to a wall.

19. The stackable trim molding system of claim 16, wherein the cove toe is integral with the wall base.

20. The stackable trim molding system of claim 16, wherein the toe has a substantially flat bottom end and is configured to sit on top of a flooring material.

21. The stackable trim molding system of claim 16, wherein the system is comprised of at least one of rubber and vulcanized rubber.

22. The stackable trim molding system of claim 16, wherein the system is comprised of thermo-plastic rubber (TPR).

23. The stackable trim molding system of claim 16, wherein the system is comprised of vinyl.

24. The stackable trim molding system of claim 16, wherein a back side of the wall base and the top trim are configured to adhere to an adhesive.

25. The stackable trim molding system of claim 16, wherein a front face of at least one of the wall base and the top trim is contoured.

26. The stackable trim molding system of claim 16, wherein the wall base and the top trim may be different colors.

27. The stackable trim molding system of claim 16, wherein the wall base and the top trim, when stacked, do not adhere to each other.

28. A stackable trim molding system comprising:
a base shoe made of a resilient, man-made material;
means for connecting to a floor to smoothly butt up against the floor; and
a wall base made of a resilient, man-made material having means for connecting with a top end of the base shoe to form a clean border with the base shoe when stacked on top of the base shoe.

29. The stackable trim molding system of claim 28, further comprising:
a top trim piece made of a resilient, man-made material; and
means for connecting configured to connect with a top end of the cove base to form a clean border with the wall base when stacked on top of the wall base.

30. A stackable trim molding system comprising:
a wall base made of a resilient, man-made material;
means for contacting a floor;
a top trim made of a resilient, man-made material; and
means for connecting with a top end of the wall base to form a clean border with the wall base when stacked on top of the wall base.

31. A method of installing trim comprising:
attaching a base shoe to a wall where a bottom part of the base shoe is proximate to a floor; and
attaching the wall base to a wall via the adhesive to where the bottom of the wall base is proximate to the top of the base shoe.

32. The method of claim 31, further comprising fitting a bottom portion of the wall base into a groove in a top portion of the base shoe.

33. The method of claim 31, further comprising stacking a top trim on top of the wall base.

34. The method of claim 31, further comprising overlapping a lip on the top trim over a portion of the wall base.

35. The method of claim 31, further comprising stacking a new top trim on top of an old wall base.

36. The method of claim 31, further comprising:
one of painting a wall and/or wallpapering a wall; and
placing a top trim portion over the paint or wallpaper and on top of the wall base.

37. The method of claim 31, further comprising fitting a portion of carpet into a groove in the base shoe.

38. The method of claim 31, further comprising replacing the base shoe but retaining the wall base.

39. A method of installing trim comprising:
attaching the wall base to a wall;
contacting a floor surface with a cove toe portion of the wall base; and
applying a top trim above the wall base.

40. The method of claim 39, further comprising overlapping a lip on the top trim over a portion of the wall base.

41. The method of claim 39, further comprising stacking a new top trim on top of an old wall base.

42. The method of claim 39, further comprising:
one of painting a wall and wallpapering a wall; and
placing a top trim portion over the paint or wallpaper and on top of the wall base.

43. A method of making trim comprising extruding a man-made, resilient material into a wall base having at least one of: a top side configured to mate with a top trim when the top trim is stacked on top of the wall base and a bottom side configured to mate with a base shoe when the wall base is stacked on top of the base shoe.

44. The method of claim 43, further comprising extruding a man-made, resilient material into a base shoe having groove running along a top side and dimensioned to have a bottom part of the wall base fit into the groove when the wall base is stacked on top of the base shoe.

45. The method of claim 44, further comprising forming a groove in a bottom part of the base shoe configured to receive a portion of carpet.

46. The method of claim 43, forming a ridge along a back side of the wall base and near a top side of the wall base.

47. The method of claim 43, further comprising extruding a top trim out of a resilient man-made material and having a lip configured to overlap the wall base when the top trim is stacked on top of the wall base.

48. The method of claim 43, further comprising forming a cove toe on the wall base.

49. The method of claim 43, further comprising using at least one of rubber, vulcanized rubber, thermo-plastic rubber (TPR), and vinyl to make the trim.

50. The method of claim 43, further comprising forming decorative contours on one or more of the wall base, a base shoe, and a top trim.

51. A stackable trim molding system comprising:
a base shoe; and wall base having a bottom end configured to communicate with a top end of the base shoe to form a clean border with the base shoe when stacked on top of the base shoe.

52. The system of claim 51, further comprising a groove in the top end of the base shoe and the wall base has a substantially flat bottom end dimensioned to fit into the groove in the top end of the base shoe.

53. A method of converting a trim molding system with a cove toe on a wall base to a non-toe system comprising trimming the toe off of a wall base.

54. The method of claim 53, wherein the wall base is already applied to a wall while the toe is trimmed.

55. The method of claim 53, further comprising attaching a base shoe to the wall base.

56. The method of claim 55, further comprising connecting a wall butting section of the base shoe to a wall.

57. The method of claim 55, further comprising inserting carpet in to a carpet groove on the base shoe.
